(19) United States
(12) Patent Application Publication
(10) Pub. No.: US 2014/0196828 A1
(43) Pub. Date: Jul. 17, 2014

(54) RUBBER COMPOSITION FOR CANVAS CHAFER, AND PNEUMATIC TIRE

(71) Applicant: SUMITOMO RUBBER INDUSTRIES, LTD., Kobe-shi (JP)

(72) Inventor: Tatsuya MIYAZAKI, Kobe-shi (JP)

(73) Assignee: SUMITOMO RUBBER INDUSTRIES, LTD., Kobe-shi (JP)

(21) Appl. No.: 14/154,872

(22) Filed: Jan. 14, 2014

(30) Foreign Application Priority Data
Jan. 15, 2013 (JP) 2013-004719

(51) Int. Cl. B60C 15/06

(52) U.S. Cl. CPC B60C 15/06
USPC 152/543

(57) ABSTRACT

Provided are a rubber composition for a canvas chafer which, despite being low cost, is excellent in rim chafing resistance, resistance to rim damage, and processability (sheeting processability, rubber flow in the tire, adhesion to adjacent components) and performs well with respect to low heat build-up, and a pneumatic tire including the composition. The invention relates to a rubber composition for a canvas chafer, including: an isoprene-based rubber; a carbon black having an N₂SA of 65-200 m²/g; and sulfur, wherein an amount of the isoprene-based rubber is 25-80% by mass and an amount of butadiene rubber is not more than 40% by mass, each based on 100% by mass of a rubber component of the rubber composition, and an amount of the carbon black is 40-80 parts by mass and an amount of the sulfur is 1.0-2.7 parts by mass, each per 100 parts by mass of the rubber component.

### TECHNICAL FIELD

The present invention relates to a rubber composition for a canvas chafer, and a pneumatic tire including such a rubber composition.

### BACKGROUND ART

The bead portion of a pneumatic tire is provided with a canvas chafer to effectively prevent the bead portion from being damaged by abrasion with a rim (rim chafing) and from being damaged during mounting to or dismounting from the rim.

Such canvas chafers, however, can develop problems such as exposure of the fabric and breakage of some cords, which are caused due to wear of the canvas chafer topping rubber during running; and high frequency of cracks in ends of the fabric or in adjacent rubbers, which is caused due to considerably high tensile stress imposed on a portion of the fabric in the chafer in the process of assembling the tire to the rim. In addition to rim chafing resistance and resistance to rim damage, also important are good performance in processability, particularly in processability of the rubber-topped fabric, and good adhesion to adjacent compounds.

Patent Literature 1 suggests a rubber composition for a canvas chafer topping which includes certain amounts of a specific butadiene rubber and carbon black, and has improved performance in rim chafing resistance, durability, low heat build-up, sheeting processability and the like. There is still a demand for another rubber composition having cost advantages while being excellent in rim chafing resistance, processability (particularly, topping processability), and resistance to rim damage.

### CITATION LIST

### Patent Literature

Patent Literature 1: JP 2012-46611 A

### SUMMARY OF INVENTION

### Technical Problem

The present invention aims to solve the above problems and provide a rubber composition for a canvas chafer which, despite being low cost, is excellent in rim chafing resistance, resistance to rim damage, and processability (sheeting processability, rubber flow in the tire, adhesion to adjacent components) and performs well with respect to low heat build-up, and a pneumatic tire including such a rubber composition.

### Solution to Problem

One aspect of the present invention is a rubber composition for a canvas chafer, comprising:

an isoprene-based rubber;

a carbon black having a nitrogen adsorption specific surface area of 65 to 200 m²/g; and

sulfur,

wherein an amount of the isoprene-based rubber is 25 to 80% by mass and an amount of butadiene rubber is not more than 40% by mass, each based on 100% by mass of a rubber component of the rubber composition, and

an amount of the carbon black is 40 to 80 parts by mass and an amount of the sulfur is 1.0 to 2.7 parts by mass, each per 100 parts by mass of the rubber component.

The rubber composition for a canvas chafer preferably comprises calcium carbonate, talc, bituminous coal, hard clay, or crushed rubber powder.

The rubber composition for a canvas chafer preferably comprises 1 to 15 parts by mass of reclaimed rubber powder having an average particle size of 100 μm to 1 mm per 100 parts by mass of the rubber component.

Another aspect of the present invention is a pneumatic tire, comprising:

a canvas chafer; and

a ply adjacent to the canvas chafer,

wherein the canvas chafer and the ply comprise, as a topping composition, the rubber composition for a canvas chafer and a rubber composition for a ply, respectively,

wherein a sulfur content in the rubber composition for a canvas chafer and a sulfur content in the rubber composition for a ply, each per 100 parts by mass of the corresponding rubber component of the rubber composition for a canvas chafer or ply, satisfy the following formula:

(the sulfur content in the rubber composition for a ply)/(the sulfur content in the rubber composition for a canvas chafer)<3.5.

### Advantageous Effects of Invention

According to the present invention, a rubber composition including a rubber component in which the isoprene-based rubber content and the butadiene rubber content are set to predetermined levels, a carbon black having a high specific surface area, and a small amount of sulfur is used in a canvas chafer topping rubber. Therefore, despite being low cost, such a rubber composition provides excellent rim chafing resistance, excellent resistance to rim damage, and excellent processability (sheeting processability, rubber flow in the tire, adhesion to adjacent components) and performs well with respect to low heat build-up.

### BRIEF DESCRIPTION OF DRAWINGS

FIG. 1 is an exemplary schematic cross-sectional view of a canvas chafer and its surroundings in a pneumatic tire.

FIG. 2 is an exemplary schematic cross-sectional view showing air trapped at the joint between a canvas chafer and a ply after vulcanization.

FIG. 3 is an exemplary schematic cross-sectional view showing a surface of a vulcanized canvas chafer that is corrugated according to the weave pattern of the fabric.

FIG. 4 is an exemplary schematic cross-sectional view explaining a method for evaluating the adhesion between a canvas chafer and an adjacent component (ply) after vulcanization.

### DESCRIPTION OF EMBODIMENTS

The rubber composition for a canvas chafer of the present invention includes a specific rubber component in which the isoprene-based rubber content and the butadiene rubber content are set to predetermined levels, a predetermined amount of a carbon black having a high nitrogen adsorption specific surface area, and a small amount of sulfur.

A canvas chafer is placed at the bottom of a bead, and may wear by abrasion between the bead and a rim particularly when too much load is imposed or during rapid acceleration or rapid deceleration. Further, an end of the fabric or an adjacent rubber may crack during assembling the tire to the rim. In the present invention, the use of a carbon black with a high specific surface area and a small amount of sulfur in combination with a rubber component containing a specific amount of an isoprene-based rubber with only a certain amount or less of butadiene rubber provides excellent rim chafing resistance and excellent resistance rim damage to a canvas chafer and thus can achieve high durability. Further, it improves the rubber flow of the topping rubber during vulcanization and thus provides excellent topping processability, and can also achieve lower heat build-up. In addition, since such a topping rubber can achieve the above performance properties with relatively cheap natural rubber, it contributes to cost reduction.

Inorganic or organic extending fillers such as calcium carbonate, talc, bituminous coal, hard clay, and crushed rubber powder, which generally have a particle size of not less than 1 μm, are unfavorable in terms of rim chafing resistance and the like, but do not turn into a gel unlike carbon black. Thus, such extending fillers make rubber compounds unlikely to scorch during extruding, and can improve sheet processability during topping, adhesion to adjacent components, and rubber retention after vulcanization. Therefore, the addition of such extending filler remarkably improves processability.

Examples of the isoprene-based rubber used in the present invention include synthetic isoprene rubber (IR), natural rubber (NR), and modified natural rubber. NR may be deproteinized natural rubber (DPNR) or highly purified natural rubber (HPNR). Examples of modified natural rubber include epoxidized natural rubber (ENR), hydrogenated natural rubber (HNR), and grafted natural rubber. Specific examples of NR include those commonly used in the tire industry, such as SIR20, RSS#3, and TSR20. In particular, NR is preferred from the viewpoints of elongation at break, resistance to rim damage, and topping processability.

The amount of the isoprene-based rubber based on 100% by mass of the rubber component is not less than 25% by mass, preferably not less than 35% by mass, and more preferably not less than 45% by mass. The amount is not more than 80% by mass and preferably not more than 75% by mass. If the amount is less than 25% by mass, the sheet processability tends to be poor. If the amount is more than 80% by mass, the resistance to reversion tends to be poor.

In the rubber composition for a canvas chafer of the present invention, the amount of butadiene rubber (BR) is not more than a certain amount.

Suitable examples of BR include BR containing 1,2-syndiotactic polybutadiene crystals (SPB), such as VCR412 and VCR617 produced by UBE INDUSTRIES, LTD., and high-cis content BR such as BR150B produced by UBE INDUSTRIES, LTD. The use of such BR provides good extrusion processability and good rim chafing resistance.

The amount of BR based on 100% by mass of the rubber component is not more than 40% by mass, preferably not more than 30% by mass, and more preferably not more than 20% by mass although BR may not be added. If the amount is more than 40% by mass, the resistance to rim damage, elongation at break, and processability tend to be reduced, which can cause a cost disadvantage.

In the present invention, rubbers other than the isoprene-based rubber and BR may be used. For example, diene rubbers such as styrene-butadiene rubber (SBR), styrene-isoprene-butadiene rubber (SIBR), ethylene-propylene-diene rubber (EPDM), chloroprene rubber (CR), and acrylonitrile-butadiene rubber (NBR) may be used. Preferred among these are SBR from the viewpoints of reversion, processability, and elongation at break.

The SBR is not particularly limited, and examples thereof include emulsion-polymerized SBR (E-SBR) and solution-polymerized SBR (S-SBR). E-SBR is preferred from the viewpoints of processability and resistance to reversion.

Based on 100% by mass of the rubber component, the amount (combined amount) of rubbers other than the isoprene-based rubber and BR is preferably not less than 20% by mass and more preferably not less than 25% by mass. If the amount is less than 20% by mass, the reversion is likely to occur and the complex modulus (E*) of the rubber compound tends to be reduced. The amount (combined amount) is preferably not more than 75% by mass and more preferably not more than 60% by mass. If the amount is more than 75% by mass, the rubber compound is poor in terms of heat build-up and processability. In cases where SBR is used as a rubber other than the isoprene-based rubber and BR, the amount thereof is also suitably as described above.

In the present invention, a carbon black having a nitrogen adsorption specific surface area (N₂SA) of 65 to 200 m²/g is used as a reinforcing filler. If the N₂SA is less than 65 m²/g, the rim chafing resistance and elongation at break tend to be reduced, leading to a reduction in durability. If the N₂SA is more than 200 m²/g, the processability and tan 6 tend to be poor. The lower limit of the N₂SA is preferably not less than 80 m²/g and more preferably not less than 110 m²/g. The upper limit thereof is preferably not more than 170 m²/g, more preferably not more than 150 m²/g, and still more preferably not more than 130 m²/g.

The nitrogen adsorption specific surface area of carbon black is measured in accordance with JIS K 6217-2:2001.

The carbon black is preferably N351H, N220, N330, N234, or N110 and particularly preferably N220, from the viewpoints of rim chafing resistance, resistance to rim damage, durability, and low heat build-up.

The amount of the carbon black per 100 parts by mass of the rubber component is not less than 40 parts by mass, preferably not less than 45 parts by mass, and more preferably not less than 50 parts by mass, in terms of providing excellent rim chafing resistance. Also, the amount of the carbon black is not more than 80 parts by mass, preferably not more than 75 parts by mass, and more preferably not more than 70 parts by mass, because such an amount does not deteriorate the heat build-up.

A carbon black having an N₂SA outside the range mentioned above may also be added as long as it does not adversely affect the performance properties.

In the present invention, silica may be added as a reinforcing filler. The use of silica improves elongation at break (EB) and resistance to rim damage, and can also provide excellent heat build-up properties.

The amount of silica per 100 parts by mass of the rubber component is preferably not less than 3 parts by mass and more preferably not less than 5 parts by mass, in terms of performing better with respect to elongation at break and low heat build-up. Also, the amount of silica is preferably not more than 15 parts by mass and more preferably not more than 13 parts by mass, in terms of providing good E* and sheet processability. When silica is added, an appropriate amount of a known silane coupling agent is preferably added to improve processability and enhance the silica dispersion.

The rubber composition for a canvas chafer of the present invention preferably contains calcium carbonate, talc, bituminous coal, hard clay, or crushed rubber powder as an extending filler. These extending fillers do not turn into a polymer gel during mixing, and therefore provide good extrusion processability and good sheet processability. Further, since excellent rim chafing resistance is ensured by the essential components according to the present invention, the addition of such extending filler contributes to a cost reduction and a reduction in environmental impact. In particular, crushed rubber powder is preferred because it is effective to keep the kinematic viscosity of the formulations in a fabric topping process, even during extruding, and thus maintain rubber retention. These extending fillers may be used alone, or two or more of these may be used in combination.

The calcium carbonate preferably has an average particle size of not more than 100 μm, more preferably not more than 50 μm and still more preferably not more than 30 μm. The lower limit of the average particle size is not particularly limited, and is preferably not less than 1 μm and more preferably not less than 2 μm. If the average particle size is more than 100 μm, then the heat build-up may be deteriorated.

The talc preferably has an average particle size of not more than 50 μm and more preferably not more than 30 μm. If the average particle size is more than 50 μm, the fuel economy may not be sufficiently improved. The lower limit of the average particle size of the talc is not particularly limited and is preferably not less than 1 μm.

The bituminous coal includes general coal. Such bituminous coal is typically provided in a pulverized form to the rubber composition.

The pulverized bituminous coal has an average particle size of not more than 50 μm, preferably not more than 30 μm. If the average particle size is more than 50 μm, the fuel economy may not be sufficiently improved. The lower limit of the average particle size of the pulverized bituminous coal is not particularly limited and is preferably not less than 1 μm.

The hard clay preferably has an average particle size of not more than 50 μm and more preferably not more than 30 μm. If the average particle size is more than 50 μm, the fuel economy may not be sufficiently improved. The lower limit of the average particle size of the hard clay is not particularly limited and is preferably not less than 0.4 μm.

The crushed rubber powder is not particularly limited, and examples thereof include rubber chip or powder made from diene rubber (e.g. NR, SBR, BR, and IR) or the like. Pulverized tread rubbers of used tires, trimmed spews and burrs and the like (pulverized waste tires), and reclaimed rubber powder prepared from waste products derived from the rubber industry are preferred from the environmental and cost viewpoints. Specifically, crushed rubber powder as stated in JIS K 6316:1988 may be used. The crushed rubber powder may be, for example, one capable of passing through a 30 Tyler mesh sieve or a 40 Tyler mesh sieve.

The crushed rubber powder such as reclaimed rubber powder preferably has an average particle size of not less than 70 μm, more preferably not less than 100 μm. The average particle size is preferably not more than 1 mm and more preferably not more than 750 μm. An average particle size of less than 70 μm may have less advantage in terms of rubber retention and may not provide the effect of improving topping processability. In addition, it may also require a high grinding cost and thus increase cost. If the average particle size is more than 1 mm, finished products may have irregularities and therefore poor appearance.

The average particle sizes of the extending fillers herein are mass average particle sizes determined from particle size distribution in accordance with JIS Z 8815:1994.

The amount of an extending filler such as crushed rubber powder (e.g., reclaimed rubber powder) per 100 parts by mass of the rubber component is preferably not less than 1 part by mass and more preferably not less than 3 parts by mass. The amount is preferably not more than 20 parts by mass and more preferably not more than 15 parts by mass. If the amount is less than 1 part by mass, the effect of the extending filler added may not be sufficient. If the amount is more than 20 parts by mass, then the resistance to rim damage and the rim chafing resistance may be poor. Furthermore, the amount within a range mentioned above generates no heat during extruding, and is effective in providing a sheet with smooth surfaces. In cases where two or more kinds of extending fillers are added, the combined amount of these extending fillers is preferably as described above.

The rubber composition for a canvas chafer of the present invention contains a certain amount of sulfur. When a small amount of sulfur is used in combination with the carbon black having a high specific surface area, the effects of the present invention can be provided. The sulfur may be one commonly used in the rubber industry, such as powdered sulfur, precipitated sulfur, colloidal sulfur, insoluble sulfur, highly dispersible sulfur, and soluble sulfur.

The amount of sulfur per 100 parts by mass of the rubber component is not less than 1.0 part by mass, preferably not less than 1.1 parts by mass, and more preferably not less than 1.2 parts by mass. From the viewpoint of degradation resistance, the amount of sulfur is preferably small. However, if the amount is less than 1.0 part by mass, the tensile strength at break tends to be reduced and the adhesion of the fabric topping rubber tends to be reduced. In addition, the vulcanization bonding to adjacent components, particularly to a carcass topping rubber, tends to be poor. Also, the amount of sulfur is not more than 2.7 parts by mass, preferably not more than 2.5 parts by mass, and more preferably not more than 2.3 parts by mass. If the amount is more than 2.7 parts by mass, the abrasion resistance tends to be reduced. In addition, the resistance to autooxidative degradation and the aged tensile properties (rim damage, tearing and cracking of the fabric topping rubber) tend to deteriorate, and the vulcanization bonding to butyl rubber also tends to be poor.

The rubber composition for a canvas chafer of the present invention may optionally include, in addition to the above ingredients, additives commonly used in the rubber industry, such as zinc oxide, various antioxidants, softeners, and various vulcanization accelerators.

The rubber composition for a canvas chafer of the present invention can be prepared by an ordinary method. Specifically, the composition may be prepared by mixing the ingredients with an apparatus such as a Banbury mixer, a kneader, or an open roll mill, and then vulcanizing the mixture.

The rubber composition for a canvas chafer of the present invention is used as a topping rubber composition for a canvas chafer.

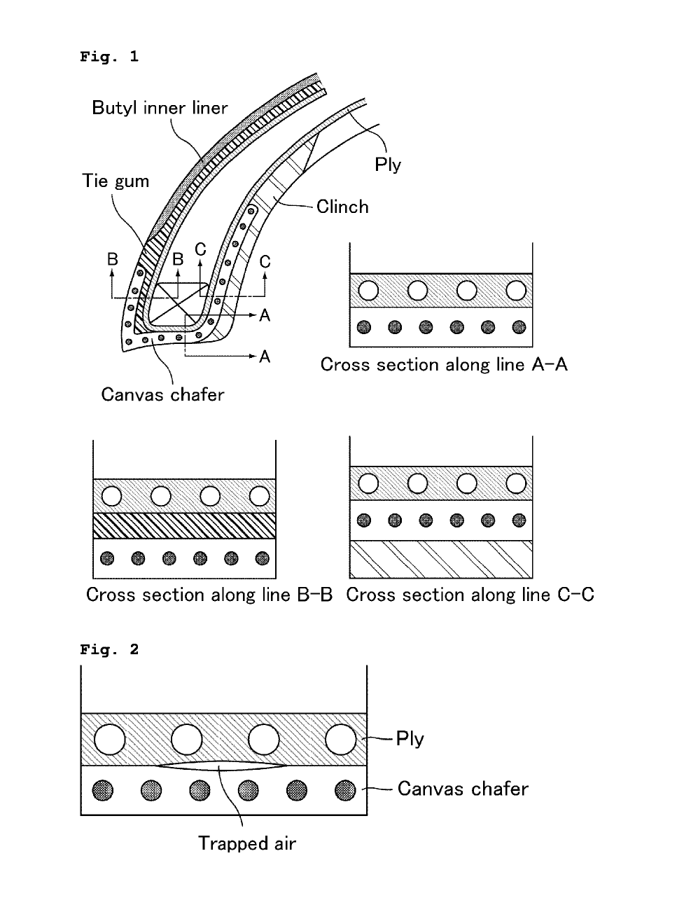

The rubber composition for a canvas chafer of the present invention is used in a topping rubber of a canvas chafer that is a component composed of a woven fabric and a topping rubber which covers the woven fabric, located around a bead, and coming into contact with a rim when assembled with the rim. Specifically, the rubber composition may be used for canvas chafers as shown in, for example, FIGS. 1 to 6 of JP 2010-52486 A, FIGS. 1 and 2 of JP 2009-127144 A, FIGS. 1 and 5 of JP 2009-160952 A, and FIGS. 1 and 2 of JP 2007-238078 A (which are incorporated by reference in their entirety). The woven fabric of a canvas chafer typically consists of a large number of warp yarns and weft yarns. The warp and weft yarns are made of organic fibers, and preferred examples of organic fibers include polyester fibers, polyethylene naphthalate fibers, and polyamide fibers (e.g. nylon fibers, aramid fibers).

The pneumatic tire of the present invention may include a canvas chafer having a topping rubber for a canvas chafer formed from the rubber composition for a canvas chafer. In particular, such a pneumatic tire may suitably include a canvas chafer and a ply, which include, as a topping composition, the rubber composition for a canvas chafer and a rubber composition for a ply, respectively, wherein the sulfur content in the rubber composition for a ply to the sulfur content in the rubber composition for a canvas chafer satisfy a specific relation described later.

In the pneumatic tire of the present invention, the amounts of the chemicals, such as sulfur, to be incorporated into the rubber composition for a canvas chafer or for a ply each refer to the amount (addition amount) in the rubber composition before vulcanization. That is, the amounts of the chemicals contained in the rubber compositions for a canvas chafer or for a ply refer to the theoretical amounts of the chemicals contained in the unvulcanized rubber composition for a canvas chafer or for a ply. The theoretical amount refers to the amount of each chemical introduced when the unvulcanized rubber composition is prepared.

The canvas chafer and its surroundings in the pneumatic tire of the present invention have, for example, a structure as shown in FIG. 1 which has laminated structures different according to the parts of the canvas chafer, as shown in the cross section along line A-A, the cross section along line B-B, and the cross section along line C-C. In other words, since the canvas chafer is adjacent to a ply, a clinch, a tie gum, or a butyl inner liner depending on the part thereof, it is expected to be adjacently co-crosslinked to each adjacent component in a sufficient manner to achieve good vulcanization bonding during the vulcanization of the unvulcanized tire. However, air may in some cases be trapped between the canvas chafer and an adjacent component after vulcanization as shown in FIG. 2, which may cause adhesion failure. If the vulcanization bonding is poorly achieved, the canvas chafer is easily separated particularly from the tie gum (or butyl inner liner) at the portion around line B-B due to the great deformation of the canvas chafer during assembling the tire to the rim and during mounting to and dismounting from the rim.

Such problems of trapped air and adhesion failure are considered to be caused by the following mechanism. The initial curing rate of the surface layer of the canvas chafer is increased by migration of sulfur from an adjacent component to the canvas chafer during vulcanization, and the canvas chafer is therefore less likely to be adjacently co-crosslinked to the adjacent component. In the present invention, in contrast, such problems can be solved by setting the ratio of the sulfur content in the rubber composition for a ply, which generally has the largest sulfur content among the adjacent components: ply, clinch, and tie gum and is thus considered to have the highest sulfur migration rate, to the sulfur content in the rubber composition for a canvas chafer within a specific range.

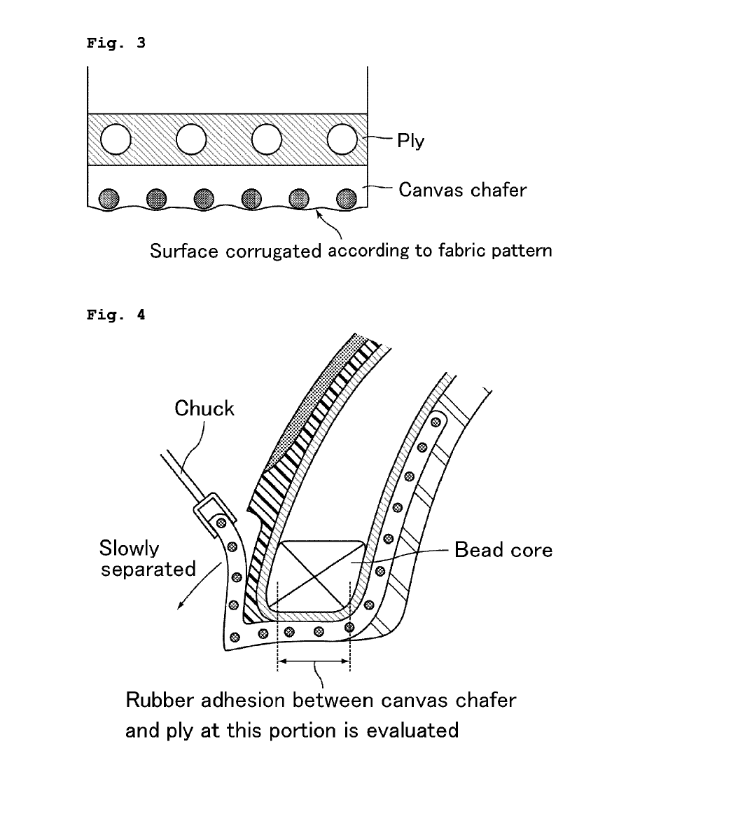

Also, in cases where the rubber flow (topping processability) of the rubber composition for a canvas chafer is in a poor condition, that is, the rubber composition is too flowable, the rubber may have a surface corrugated according to the weave pattern of the fabric as shown in FIG. 3 or the fabric (the cord pattern of nylon cords) may be exposed. However, in the rubber composition for a canvas chafer of the present invention, since the rubber flow of the topping rubber is properly kept during vulcanization as described above, the problem as shown in FIG. 3 can be prevented.

In the pneumatic tire, the sulfur content in the rubber composition for a canvas chafer and the sulfur content in the rubber composition for a ply satisfy the following formula:

(the sulfur content in the rubber composition for a ply)/(the sulfur content in the rubber composition for a canvas chafer)≦3.5.

If the ratio of the sulfur contents is more than 3.5, the canvas chafer and the ply tend to differ in initial curing rate t10 and are less likely to be adjacently co-crosslinked to each other; therefore, the adhesion tends to be reduced.

The ratio (addition ratio) of the sulfur contents is not particularly limited as long as it is not more than 3.5, and is preferably 0.90 to 2.5 and more preferably 1.2 to 2.2.

The rubber component to be used in the rubber composition for a ply of the pneumatic tire is not particularly limited, and may include diene rubbers as mentioned for the rubber composition for a canvas chafer. In particular, NR and SBR are preferred, and combination use of NR and SBR is more preferred. The NR and SBR are not particularly limited, and may be as mentioned for the rubber composition for a canvas chafer.

In the rubber composition for a ply, the amount of NR based on 100% by mass of the rubber component is preferably 50 to 100% by mass and more preferably 60 to 80% by mass. The amount of SBR based on 100% by mass of the rubber component is preferably 10 to 50% by mass and more preferably 20 to 40% by mass.

The sulfur to be used in the rubber composition for a ply is not particularly limited, and may be as mentioned for the rubber composition for a canvas chafer.

The sulfur content in the rubber composition for a ply is preferably 1.91 to 3.5 parts by mass, more preferably 2.41 to 3.1 parts by mass, and still more preferably 2.42 to 3.0 parts by mass, per 100 parts by mass of the rubber component.

The rubber composition for a ply may contain carbon black.

The carbon black, if used, preferably has a nitrogen adsorption specific surface area (N₂SA) of 40 to 150 m²/g, more preferably 60 to 100 m²/g. The amount of carbon black is preferably 10 to 90 parts by mass and more preferably 20 to 60 parts by mass per 100 parts by mass of the rubber component.

In order to improve the adhesion to cords, the rubber composition for a ply may contain at least one compound selected from the group consisting of resorcin resins (condensates), modified resorcin resins (condensates), cresol resins, and modified cresol resins, in combination with a methylene donor. Further, additives conventionally used in the rubber industry as described above may also be added.

Vulcanization accelerators as mentioned for the rubber composition for a canvas chafer can be suitably used. The amount of vulcanization accelerator is preferably 0.3 to 2.5 parts by mass and more preferably 0.8 to 1.7 parts by mass per 100 parts by mass of the rubber component.

The rubber composition for a ply can be prepared as described above for the rubber composition for a canvas chafer.

The pneumatic tire of the present invention can be formed using the rubber composition for a canvas chafer by an ordinary method, specifically as follows. Sheets of the rubber composition for a canvas chafer containing the above ingredients are set to sandwich a woven fabric and rolled with rolls from above and below to prepare a rubberized sheet. The obtained rubberized sheet is cut into a predetermined size, and the resulting component is molded with other tire components such as a ply in a tire building machine by an ordinary method to form an unvulcanized tire. Then, the unvulcanized tire is heated and pressurized in a vulcanizer to produce a tire.

The pneumatic tire of the present invention is suitable for passenger vehicles, commercial vehicles (light trucks), trucks and buses, industrial vehicles, and the like, and is particularly suitable for passenger vehicles and commercial vehicles.

### EXAMPLES

The present invention is more specifically described with reference to examples, and the present invention is not limited to these examples.

Chemicals used in the examples and comparative examples are listed below.
NR: TSR20
IR: IR2200 produced by JSR Corporation
BR (1): VCR617 produced by UBE INDUSTRIES, LTD.
BR (2): BR150B produced by UBE INDUSTRIES, LTD.
E-SBR (1): SBR1502 (emulsion-polymerized styrene-butadiene rubber, styrene unit content 23.5% by mass) produced by JSR Corporation
E-SBR (2): Nipol1502 (emulsion-polymerized styrene-butadiene rubber, styrene unit content 23.5% by mass) produced by ZEON CORPORATION
Silica: Ultrasil VN3 (N₂SA: 175 m²/g) produced by Degussa Carbon black (1): N550 (N₂SA: 53 m²/g) produced by Cabot Japan K.K.
Carbon black (2): N351H (N₂SA: 72 m²/g) produced by Cabot Japan K.K.
Carbon black (3): N330 (N₂SA: 82 m²/g) produced by Cabot Japan K.K.
Carbon black (4): N220 (N₂SA: 118 m²/g) produced by Cabot Japan K.K.
Carbon black (5): N234 (N₂SA: 145 m²/g) produced by Cabot Japan K.K.
Carbon black (6): HP160 (N₂SA: 165 m²/g) produced by Columbian Carbon
Extending filler (1): W2-A (crushed rubber powder: 30 mesh, polymer content: 52% by mass, carbon black content: 32% by mass, average particle size: 500 pm, specific gravity: 1.14) produced by MURAOKA RUBBER RECLAIMING Co., Ltd. Extending filler (2): PD-200-TR (crushed rubber powder: 200 mesh, polymer content: 50% by mass, carbon black content: 30% by mass, average particle size: 75 μm, specific gravity: 1.14) produced by Lehigh Technologies Inc. Extending filler (3): Calcium carbonate 200 (calcium carbonate, average particle size: 2.7 μm, specific gravity: 2.68, N₂SA: 1.5 m²/g) produced by TAKEHARA KAGAKU KOGYO CO., LTD.
Extending filler (4): Crown clay (hard clay, average particle size: 0.6 μm) produced by Southeastern Clay Company
Extending filler (5): AUSTIN BLACK 325 (pulverized bituminous coal, average particle size: 5.5 μm, oil content: 17% by mass, specific gravity: 1.3, N₂SA: 9.0 m²/g) produced by Coal Fillers Inc.
Softener: TDAE oil produced by Japan Energy Corporation
Antioxidant: FLECTOL TMQ produced by FLEXSYS
Stearic acid: Stearic acid produced by NOF Corporation
Zinc oxide: Zinc oxide #1 produced by Mitsui Mining & Smelting Co., Ltd.
Insoluble sulfur: SEIMI sulfur (insoluble sulfur with a carbon disulfide-insoluble content of 60% or higher, oil content: 10% by mass) produced by Nippon Kanryu Industry Co., Ltd.
Vulcanization accelerator (TBBS): NOCCELER NS (N-tert-butyl-2-benzothiazolylsulfenamide) produced by OUCHI SHINKO CHEMICAL INDUSTRIAL CO., LTD.

### EXAMPLES AND COMPARATIVE EXAMPLES

According to the formulation amounts shown in Table 1, the chemicals other than the sulfur and vulcanization accelerator were mixed for 5 minutes using a Banbury mixer, and discharged at 160° C. The sulfur and vulcanization accelerator were added to the resulting mixture, and the contents were mixed for 4 minutes up to 105° C. using an open roll mill. Thus, an unvulcanized rubber composition for a canvas chafer was prepared. The obtained unvulcanized rubber composition was vulcanized at 170° C. for 12 minutes to prepare a vulcanized rubber composition for a canvas chafer.

According to the formulation amounts shown in the margin of Table 1, the chemicals other than the sulfur and vulcanization accelerator were mixed for 5 minutes using a Banbury mixer, and discharged at 160° C. The sulfur and vulcanization accelerator were added to the resulting mixture, and the contents were mixed for 4 minutes up to 105° C. using an open roll mill. Thus, an unvulcanized rubber composition for a ply was prepared.

The obtained unvulcanized rubber composition for a canvas chafer was extruded using an extruder equipped with a die of a predetermined shape to prepare a 0.5-mm thick rubber sheet. The rubber sheets were placed on the both sides of a canvas chafer fabric (440 dtex/1, nylon cord (cord diameter 0.45 mm)) and rolled with rolls. The resulting sheet was cut into a canvas chafer shape. Subsequently, the prepared canvas chafer, a ply formed from the unvulcanized rubber composition for a ply, and other tire components were assembled in a tire building machine by an ordinary method to prepare a raw cover. The raw cover was vulcanized with steam at 25 kgf/cm² at 170° C. in a mold to prepare a test tire (tire size: 215/45R17, tire for passenger vehicles).

The unvulcanized rubber compositions for a canvas chafer, the vulcanized rubber compositions for a canvas chafer, and test tires were evaluated as follows, and the results are shown in Table 1.

### <Rubber Complex Modulus (E*)>

The complex modulus E* (MPa) of each vulcanized rubber composition was measured at 70° C. using a viscoelasticity spectrometer produced by Iwamoto Seisakusho Co., Ltd. at an initial strain of 10%, a dynamic strain of 2%, and a frequency of 10 Hz. Greater E* values indicate higher rigidity. Also, E* values within the target range indicate excellent resistance to permanent set and excellent handling stability.

### <Heat Build-Up>

The loss tangent tan δ of each vulcanized rubber composition was measured at 70° C. using a viscoelasticity spectrometer produced by Iwamoto Seisakusho Co., Ltd. at an initial strain of 10%, a dynamic strain of 2%, and a frequency of 10 Hz. Smaller tan 6 values indicate lower heat build-up.

### <Resistance to Damage Due to Rim Assembling (Elongation at Break)>

Each vulcanized rubber composition was cut to prepare a test piece (No. 3 dumbbell). The elongation at break (EB (%)) of the vulcanized rubber test piece was measured by performing a tensile test in accordance with JIS K 6251 “Rubber, vulcanized or thermoplastic—Determination of tensile stress-strain properties”. Larger EB values (%) indicate higher durability and better resistance to damage due to rim assembling.

### <Rim Chafing Resistance (Abrasion Resistance Index)>

Each test tire was run on a drum at 20 km/h for 600 hours under a 230% load of the maximum load (the maximum internal pressure conditions) of the JIS standard, and the wear depth in the bead seating area was then measured. The wear depth of each of the test tires different in formulation is expressed as an index (rim chafing resistance index) relative to that of Comparative Example 1 (=100), calculated from the following equation. A tire with a higher rim chafing resistance index is less likely to cause rim slippage and to wear (i.e., such a tire has better rim chafing resistance).

(Rim chafing resistance index)=(Wear depth of Comparative Example 1)/(Wear depth of each formulation)×100

### <Processability 1>

### (Sheeting Processability, Topping Processability)

Each unvulcanized rubber composition was fed into a cold feed extruder and extruded under conditions to form a sheet with a size of 0.5 mm in thickness x about 2 m in width. The resulting sheet was visually observed and evaluated for flatness of the sheet surface, irregularities along the outer edge of the sheet, and the presence of cured bits.

Further, in each prepared test tire, the rubber flow was evaluated by visually observing the amount of the topping rubber retained on the fabric after vulcanization (visually observing whether the weave pattern of the fabric was visible or not in the tire bead seating area). A desired condition of the rubber flow is that the rubber appropriately penetrates inside the strands of the cords so that a cord-bonding reaction can be carried out, without forming large corrugations due to rubber flowing. If too much rubber flows, the fabric (the cord pattern of nylon cords) is exposed enough to catch a fingernail on when scratched with the fingernail.

The above evaluation results were collectively considered, and are expressed as an index relative to that of Comparative Example 1 (=100). A higher index indicates better sheeting processability and rubber flow.

### <Processability 2>

### (Adhesion to Adjacent Component)

As shown in FIG. 4, a knife was inserted in an edge of the canvas chafer of each tire, and the canvas chafer was held with a chuck and slowly separated from the tie gum and then the ply. The amount of rubber attached to the cords after separation (that is, the adhesion to the cords) was visually observed and evaluated. The adhesion results are expressed as an index relative to that of Comparative Example 2 (=100). A sample with an adhesion index of 100 has process suitability. An index of 110 indicates that the sample had no trapped air and no portion that was smoothly separated from rubber and thus the rubber was well attached. An index of 90 indicates that the rubber was poorly attached because, for example, air was trapped or the cord adhesion layer was broken, and therefore such a sample does not have process suitability.

TABLE 1

| | | | Example | | | | | | | | | |
|---|---|---|---|---|---|---|---|---|---|---|---|---|
| Rubber composition for canvas chafer | | | 1 | 2 | 3 | 4 | 5 | 6 | 7 | 8 | 9 | 10 |
| Formulation | NR | | 70 | 70 | 70 | 70 | 70 | 70 | 70 | 50 | 25 | 80 |
| (part(s) by mass) | IR | | — | — | — | — | — | — | — | — | — | — |
| | BR(1) | | — | — | — | — | — | — | — | 20 | 20 | 20 |
| | BR(2) | | — | — | — | — | — | — | — | — | — | — |
| | E-SBR(1) | | 30 | 30 | 30 | 30 | 30 | 30 | 30 | 30 | 55 | — |
| | Silica | | — | — | — | 10 | — | — | — | — | — | — |
| | Carbon | (1) N550 (53 m²/g) | — | — | 10 | — | — | — | — | — | — | — |
| | black | (2) N351H (72 m²/g) | — | — | — | — | — | 40 | — | — | — | — |
| | | (3) N330 (82 m²/g) | — | 15 | — | — | — | — | — | — | — | — |
| | | (4) N220 (118 m²/g) | 55 | 40 | 45 | 50 | 40 | 20 | — | 52 | 52 | 55 |
| | | (5) N234 (145 m²/g) | — | — | — | — | — | — | 47 | — | — | — |
| | | (6) HP160 (165 m²/g) | — | — | — | — | 10 | — | — | — | — | — |
| | Extending | (1) Rubber powder, | — | — | — | — | — | — | — | — | — | — |
| | filler | average particle size | | | | | | | | | | |
| | | 500 μm | | | | | | | | | | |
| | | (2) Rubber powder, | — | — | — | — | — | — | — | — | — | — |
| | | average particle size | | | | | | | | | | |
| | | 75 μm | | | | | | | | | | |
| | | (3) Calcium carbonate | — | — | — | — | — | — | — | — | — | — |
| | | (4) Hard clay | — | — | — | — | — | — | — | — | — | — |
| | | (5) Bituminous coal | — | — | — | — | — | — | — | — | — | — |
| | Softener | | 5 | 5 | 3 | 5 | 10 | 3 | 10 | 5 | 5 | 5 |
| | Antioxidant | | 1 | 1 | 1 | 1 | 1 | 1 | 1 | 1 | 1 | 1 |
| | Stearic acid | | 2.5 | 2.5 | 2.5 | 2.5 | 2.5 | 2.5 | 2.5 | 2.5 | 2.5 | 2.5 |
| | Zinc oxide | | 4 | 4 | 4 | 4 | 4 | 4 | 4 | 4 | 4 | 4 |
| | Insoluble sulfur (oil content: 10%) | | 1.6 | 1.6 | 1.6 | 1.6 | 1.6 | 1.6 | 1.6 | 1.6 | 1.4 | 15 |
| | Net sulfur content | | (1.44) | (1.44) | (1.44) | (1.44) | (1.44) | (1.44) | (1.44) | (1.44) | (1.26) | (1.44) |
| | Vulcanization | | 0.7 | 0.7 | 0.7 | 0.7 | 0.7 | 0.7 | 0.7 | 0.7 | 0.7 | 0.7 |
| | accelerator | | | | | | | | | | | |
| Ratio of sulfer content in rubber composition | | | 2.08 | 2.08 | 2.08 | 2.08 | 2.08 | 2.08 | 2.08 | 2.08 | 2.38 | 2.08 |
| for ply to sulfur content in rubber composition | | | | | | | | | | | | |
| for canvas chafer in tire | | | | | | | | | | | | |
| Evaluation | Complex modulus (E* at | | 4.55 | 4.23 | 4.05 | 4.55 | 4.71 | 4.66 | 4.51 | 4.45 | 4.53 | 4.71 |
| | 70° C.) Target 4.0 to 5.5 | | | | | | | | | | | |
| | Heat build-up (tan δ at | | 0.221 | 0.205 | 0.194 | 0.217 | 0.227 | 0.185 | 0.234 | 0.222 | 0.250 | 0.246 |
| | 70° C.) Target ≦0.25 | | | | | | | | | | | |
| | Resistance to damage due to rim | | 655 | 625 | 610 | 680 | 670 | 630 | 685 | 605 | 600 | 700 |
| | assembling (EB %) Target ≧600 | | | | | | | | | | | |
| | Rim chafing resistance (abrasion | | 110 | 106 | 105 | 105 | 118 | 105 | 125 | 120 | 115 | 110 |
| | resistance index) Target ≧105 | | | | | | | | | | | |
| | Processability 1 | | 110 | 112 | 120 | 102 | 100 | 110 | 102 | 117 | 108 | 115 |
| | (sheeting processability, topping | | | | | | | | | | | |
| | processability) Target ≧100 | | | | | | | | | | | |
| | Processability 2 | | 115 | 115 | 115 | 125 | 125 | 115 | 120 | 115 | 115 | 130 |
| | (adhesion to adjacent | | | | | | | | | | | |
| | component) Target ≧100 | | | | | | | | | | | |
| | | | | Example | | | | | | | | |
| Rubber composition for canvas chafer | | | | 11 | 12 | 13 | 14 | 15 | 16 | 17 | 18 | 19 |
| Formulation | NR | | | 70 | 70 | 70 | 50 | 70 | 70 | 70 | 70 | 50 |
| (part(s) by mass) | IR | | | — | — | — | — | — | — | — | — | — |
| | BR(1) | | | — | — | — | 20 | — | — | — | — | 30 |
| | BR(2) | | | — | — | — | — | — | — | — | — | — |
| | E-SBR(1) | | | 30 | 30 | 30 | 30 | 30 | 30 | 30 | 30 | 20 |
| | Silica | | | — | — | — | — | — | — | — | 5 | — |
| | Carbon | (1) N550 (53 m²/g) | | — | — | — | — | — | — | — | — | — |
| | black | (2) N351H (72 m²/g) | | — | — | — | — | — | — | — | — | — |
| | | (3) N330 (82 m²/g) | | — | — | — | — | — | — | — | — | — |
| | | (4) N220 (118 m²/g) | | 52 | 52 | 52 | 52 | 52 | 52 | — | 50 | 52 |
| | | (5) N234 (145 m²/g) | | — | — | — | — | — | — | 47 | — | — |
| | | (6) HP160 (165 m²/g) | | — | — | — | — | — | — | — | — | — |
| | Extending | (1) Rubber powder, average | | 3 | 6 | — | — | — | — | — | — | — |
| | filler | particle size 500 μm | | | | | | | | | | |
| | | (2) Rubber powder, average | | — | — | 10 | — | — | — | 15 | — | — |
| | | particle size 75 μm | | | | | | | | | | |
| | | (3) Calcium carbonate | | — | — | — | 3 | — | — | — | — | — |
| | | (4) Hard clay | | — | — | — | — | 3 | — | — | — | — |
| | | (5) Bituminous coal | | — | — | — | — | — | 3 | — | — | — |
| | Softener | | | 5 | 5 | 5 | 5 | 5 | 5 | 10 | 5 | 5 |
| | Antioxidant | | | 1 | 1 | 1 | 1 | 1 | 1 | 1 | 1 | 1 |
| | Stearic acid | | | 2.5 | 2.5 | 2.5 | 2.5 | 2.5 | 2.5 | 2.5 | 2.5 | 2.5 |
| | Zinc oxide | | | 4 | 4 | 4 | 4 | 4 | 4 | 4 | 4 | 4 |
| | Insoluble sulfur (oil content: 10%) | | | 1.6 | 1.6 | 1.6 | 1.6 | 1.6 | 1.6 | 1.6 | 1.2 | 3 |
| | Net sulfur content | | | (1.44) | (1.44) | (1.44) | (1.44) | (1.44) | (1.44) | (1.44) | (1.08) | (2.7) |
| | Vulcanization ccelerator | | | 0.7 | 0.7 | 0.7 | 0.7 | 0.7 | 0.7 | 0.7 | 2.5 | 0.45 |
| Ratio of sulfer content in rubber composition for ply to sulfur | | | | 2.08 | 2.08 | 2.08 | 2.08 | 2.08 | 2.08 | 2.08 | 2.78 | 1.11 |
| content in rubber composition for canvas chafer in tire | | | | | | | | | | | | |
| Evaluation | Complex modulus (E* at 70° C.) Target | | | 4.21 | 4.31 | 4.33 | 4.20 | 4.37 | 4.18 | 4.51 | 4.12 | 4.35 |
| | 4.0 to 5.5 | | | | | | | | | | | |
| | Heat build-up (tan δ at 70° C.) Target ≦0.25 | | | 0.217 | 0.219 | 0.220 | 0.219 | 0.227 | 0.220 | 0.234 | 0.195 | 0.211 |
| | Resistance to damage due to rim assembling | | | 655 | 640 | 635 | 645 | 615 | 605 | 685 | 600 | 615 |
| | (EB %) Target ≧600 | | | | | | | | | | | |
| | Rim chafing resistance (abrasion | | | 108 | 106 | 105 | 105 | 105 | 105 | 106 | 106 | 105 |
| | resistance index) Target ≧105 | | | | | | | | | | | |
| | Processability 1 | | | 115 | 120 | 110 | 109 | 116 | 110 | 102 | 106 | 115 |
| | (sheeting processability, topping | | | | | | | | | | | |
| | processability) Target ≧100 | | | | | | | | | | | |
| | Processability 2 | | | 110 | 110 | 115 | 110 | 110 | 110 | 115 | 105 | 115 |
| | (adhesion to adjacent component) | | | | | | | | | | | |
| | Target ≧100 | | | | | | | | | | | |
| | | | Comparative Example | | | | | | | | | |
| Rubber composition for canvas chafer | | | 1 | 2 | 3 | 4 | 5 | 6 | 7 | 8 | 9 | 10 |
| Formulation | NR | | 40 | 40 | 10 | 85 | 70 | 50 | 60 | 50 | 70 | 70 |
| (part(s) by mass) | IR | | — | — | 10 | — | — | 20 | — | 20 | — | — |
| | BR(1) | | — | 60 | — | — | — | — | 40 | — | — | — |
| | BR(2) | | 60 | — | — | — | — | — | — | — | — | — |
| | E-SBR(1) | | — | — | 80 | 15 | 30 | 30 | — | 30 | 30 | 30 |
| | Silica | | — | — | — | — | — | — | — | — | — | — |
| | Carbon | (1) N550 (53 m²/g) | — | — | — | — | — | — | — | 35 | — | — |
| | black | (2) N351H (72 m²/g) | — | — | — | — | — | — | — | — | — | — |
| | | (3) N330 (82 m²/g) | — | — | — | — | — | — | — | — | — | — |
| | | (4) N220 (118 m²/g) | 55 | 55 | 55 | 58 | 55 | 55 | 50 | 30 | — | — |
| | | (5) N234 (145 m²/g) | — | — | — | — | — | — | — | — | — | — |
| | | (6) HP160 (165 m²/g) | — | — | — | — | — | — | — | — | 38 | — |
| | Extending | (1) Rubber powder, | — | — | — | — | — | — | — | — | — | — |
| | | average particle | | | | | | | | | | |
| | | size 500 μm | | | | | | | | | | |
| | filler | (2) Rubber powder, | — | — | — | — | — | — | — | — | 10 | — |
| | | average particle | | | | | | | | | | |
| | | size 75 μm | | | | | | | | | | |
| | | (3) Calcium carbonate | — | — | — | — | — | — | — | — | — | — |
| | | (4) Hard clay | — | — | — | — | — | — | — | — | — | — |
| | | (5) Bituminous coal | — | — | — | — | — | — | — | — | — | — |

| | Softener | 5 | 5 | 5 | 5 | 5 | 5 | 5 | 3 | 5 | 5 |
|---|---|---|---|---|---|---|---|---|---|---|---|
| | Antioxidant | 1 | 1 | 1 | 1 | 1 | 1 | 1 | 1 | 1 | 1 |
| | Stearic acid | 2 | 2 | 2.5 | 2.5 | 2.5 | 2.5 | 2.5 | 2.5 | 2.5 | 2.5 |
| | Zinc oxide | 4 | 4 | 4 | 4 | 4 | 4 | 4 | 4 | 4 | 4 |
| | Insoluble sulfur | 3.1 | 3.1 | 1.6 | 1.6 | 1.1 | 3.3 | 3.3 | 1.6 | 1.6 | 0.8 |
| | (oil content: 10%) | | | | | | | | | | |
| | Net sulfur content | (2.79) | (2.79) | (1.44) | (1.44) | (0.99) | (2.97) | (2.97) | (1.44) | (1.44) | (0.72) |
| | Vulcanization | 0.5 | 0.5 | 0.7 | 0.7 | 2 | 0.4 | 0.4 | 0.7 | 0.7 | 3.2 |
| | accelerator | | | | | | | | | | |
| Ratio of sulfer content in rubber composition | | 1.07 | 1.07 | 2.08 | 2.08 | 3.03 | 1.01 | 1.01 | 2.08 | 2.08 | 4.16 |
| for ply to sulfur content in rubber composition for | | | | | | | | | | | |
| canvas chafer in tire | | | | | | | | | | | |
| Evaluation | Complex modulus (E* at | 4.65 | 4.95 | 5.15 | 4.12 | 4.49 | 4.55 | 4.32 | 4.33 | 4.78 | 4.51 |
| | 70° C.) Target 4.0 to 5.5 | | | | | | | | | | |
| | Heat build-up (tan δ at | 0.213 | 0.220 | 0.265 | 0.251 | 0.207 | 0.221 | 0.212 | 0.199 | 0.256 | 0.2 |
| | 70° C.) Target ≦0.25 | | | | | | | | | | |
| | Resistance to damage due to rim | 535 | 515 | 545 | 670 | 535 | 705 | 555 | 605 | 575 | 510 |
| | assembling (EB %) Target ≧600 | | | | | | | | | | |
| | Rim chafing resistance (abrasion | 100 | 115 | 90 | 105 | 124 | 82 | 100 | 75 | 115 | 127 |
| | resistance index) Target ≧105 | | | | | | | | | | |
| | Processability 1 | 100 | 110 | 95 | 103 | 110 | 110 | 120 | 90 | 80 | 90 |
| | (sheeting processability, topping | | | | | | | | | | |
| | processability) Target ≧100 | | | | | | | | | | |
| | Processability 2 | 110 | 100 | 105 | 115 | 85 | 120 | 100 | 110 | 105 | 60 |
| | (adhesion to adjacent | | | | | | | | | | |
| | component) Target ≧100 | | | | | | | | | | |

Formulation of rubber composition for ply:
NR 70 parts,
E-SBR (2) 30 parts,
silica 5 parts,
carbon black (3) 40 parts,
softener 9 parts,
antioxidant 1 part,
zinc oxide 5 parts,
stearic acid 2 parts,
insoluble sulfur 3.33 parts (sulfur content 2.997 parts),
vulcanization accelerator 1 part

Table 1 shows that the use of an isoprene-based rubber, a carbon black having a high specific surface area, and an appropriate amount of sulfur provides excellent rim chafing resistance, excellent resistance to damage due to rim assembling, and excellent processability, as well as lower heat build-up, without using a large amount of butadiene rubber.

The table also shows that when the ratio of the sulfur content in the rubber composition for a ply to the sulfur content in the rubber composition for a canvas chafer in a pneumatic tire is set to a specific value, the rubber composition for a canvas chafer has good adhesion to an adjacent component and remarkably improved processability.

1. A pneumatic tire, comprising
a canvas chafer comprising, as a topping composition, a rubber composition for a canvas chafer,
wherein the rubber composition for a canvas chafer comprises:
an isoprene-based rubber;
a carbon black having a nitrogen adsorption specific surface area of 65 to 200 m²/g; and
sulfur,
wherein in the rubber composition for a canvas chafer, an amount of the isoprene-based rubber is 25 to 80% by mass and an amount of butadiene rubber is not more than 40% by mass, each based on 100% by mass of a rubber component of the rubber composition for a canvas chafer, and
an amount of the carbon black is 40 to 80 parts by mass and an amount of the sulfur is 1.0 to 2.7 parts by mass, each per 100 parts by mass of the rubber component.

2. The pneumatic tire according to claim 1,
wherein the rubber composition for a canvas chafer comprises calcium carbonate, talc, bituminous coal, hard clay, or crushed rubber powder.

3. The pneumatic tire according to claim 1,
wherein the rubber composition for a canvas chafer comprises 1 to 15 parts by mass of reclaimed rubber powder having an average particle size of 100 μm to 1 mm per 100 parts by mass of the rubber component.

4. The pneumatic tire according to claim 1, further comprising
a ply adjacent to the canvas chafer, which comprises, as a topping composition, a rubber composition for a ply,
wherein a sulfur content in the rubber composition for a canvas chafer and a sulfur content in the rubber composition for a ply, each per 100 parts by mass of the corresponding rubber component of the rubber composition for a canvas chafer or ply, satisfy the following formula:
(the sulfur content in the rubber composition for a ply)/(the sulfur content in the rubber composition for a canvas chafer)≦3.5.
